(19) United States
(12) Patent Application Publication
(10) Pub. No.: US 2004/0089038 A1
(43) Pub. Date: May 13, 2004

(54) Bar lock for double sliding door

(75) Inventor: Nobuyuki Iijima, Matsudo-shi (JP)

Correspondence Address: PAUL A. GUSS, PAUL A. GUSS ATTORNEY AT LAW, 775 S 23RD ST FIRST FLOOR SUITE 2, ARLINGTON, VA, 22202

(73) Assignee: Yumekobo Inc.

(21) Appl. No.: 10/292,474

(22) Filed: Nov. 13, 2002

(51) Int. Cl. E05B 65/12; E05B 47/02

(52) U.S. Cl. 70/257; 70/280

(57) ABSTRACT

A main body has a drive unit and a bar. When the drive unit is driven, the bar is inserted into frames. Accordingly, an inner panel and an outer panel are fixed.

### BACKGROUND OF THE INVENTION

1. Field of the Invention

The present invention relates to a bar lock for a double sliding door which locks or unlocks simultaneously a plurality of double sliding doors in accordance with an operation signal transmitted from a remote controller.

2. Description of the Related Art

Conventionally, a double sliding door in a building or a house is generally locked by a rotary type lock, i.e., crescent lock. The conventional lock includes a lock which is interposed between a double sliding door and a head jamb so that the door is not moved, and a lock which is attached to a double sliding door to fix door panels to one another so that the door is not moved.

However, if a window glass of the door is broken from the outside of the building, a hole is formed through the window glass and the lock can be easily unlocked from the outside of the building. If the doors are disposed in different rooms of the building, it is necessary to lock the respective doors manually from the inside of the building.

### SUMMARY OF THE INVENTION

An object of the present invention is to provide a bar lock for a double sliding door which cannot be unlocked easily even if a window glass of the door is broken. Another object of the present invention is to provide bar locks for double sliding doors which can be unlocked or locked simultaneously from the inside of a building.

A bar lock for a double sliding door of the present invention comprises a receiver unit for receiving an operation signal transmitted from a remote controller, a bar for locking the door, a drive unit for moving the bar on the basis of the operation signal, and a power source. The door is locked or unlocked in accordance with the movement of the bar. The door is locked when the bar is inserted into a frame of the door.

A bar lock for a double sliding door of the present invention comprises a receiver unit for receiving an operation signal transmitted from a remote controller, a bar for locking the door, a drive unit for moving the bar on the basis of the operation signal, a power source, and a fixing unit for fixing the bar when the door is locked in accordance with the movement of the bar. The door is locked or unlocked in accordance with the movement of the bar. The door is locked when a crescent lock installed to the door is fixed by the bar.

According to the present invention, the overall operations for locking or unlocking a plurality of doors are collectively controlled by the operation signal outputted from the remote controller arranged in a building. Accordingly, the doors, which are installed in respective rooms of the building, can be locked or unlocked. Further, when the door is locked by the bar, the bar does not protrude from the bar lock and the frame. Accordingly, even if a window glass of the door is broken, it is difficult to unlock the door. Therefore, the bar lock of the present invention is extremely useful for prevention of crime and security on the double sliding door.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic view of a bar lock according to an embodiment of the present invention;

FIG. 2 is an internal structure view of the bar lock shown in FIG. 1;

FIG. 3 is a view of a window frame installed the bar lock shown in FIG. 1 and FIG. 2;

FIG. 4 is a view of the bar lock attached on a front of the frame shown in FIG. 3;

FIG. 5 is a view of the bar lock on the side of the frame shown in FIG. 3;

FIG. 6 is a view of the bar lock attached on the front of the frame shown in FIG. 3, and a crescent lock attached on the side of the frame shown in FIG. 3;

FIG. 7 is a view of the bar lock embedded in the frame shown in FIG. 3; and

FIG. 8 is a view of the bar lock embedded in the frame shown in FIG. 3 or a wall.

### DESCRIPTION OF THE PREFERRED EMBODIMENTS

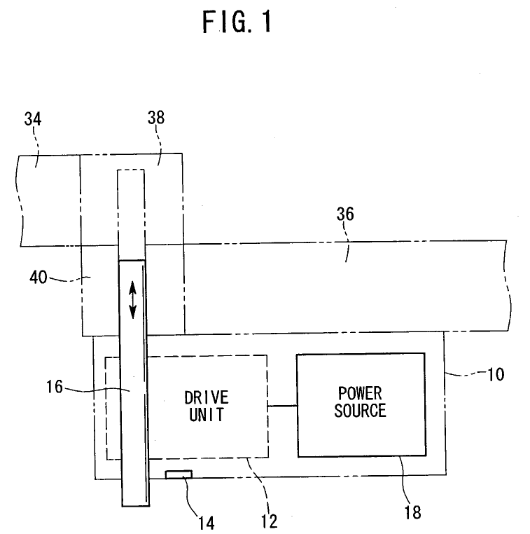

FIG. 1 shows a bar lock for a double sliding door according to an embodiment of the present invention. The bar lock has a main body 10. The main body 10 includes a drive unit 12, a receiver unit 14, a bar 16, and a power source 18. When the receiver unit 14 receives an operation signal transmitted from an unillustrated remote controller, the drive unit 12 is controlled on the basis of the operation signal. When the operation signal is a lock signal, then the drive unit 12 is driven on the basis of the lock signal, and the bar 16 can be moved. Accordingly, the bar 16 penetrates through a frame 38, 40, and the double sliding door is locked. In this situation, the bar 16 is inserted into a frame 38 of the door so that the bar 16 does not protrude from the main body 10 and the frames 38, 40. When the door is unlocked, an unlock signal is transmitted from the remote controller to the receiver unit 14.

When the receiver unit 14 receives the unlock signal, then the drive unit 12 is driven, and the bar 16 is pulled out from the frame 38. The operation signal, which is infrared ray, ultrasonic wave, radio wave or the like, is transmitted from the unillustrated remote controller to the receiver unit 14. The remote controller may be a controller which is used to lock or unlock a door of an automobile or the like.

In order to lock or unlock doors disposed in different rooms simultaneously and collectively in a building, the operation signal, which is based on infrared ray, ultrasonic wave, or radio wave, is transmitted from the remote controller to the receiver unit 14 of each of the bar locks attached on the doors. If the operation signal does not arrive at the bar lock, an unillustrated relay unit is arranged between the remote controller and the receiver unit 14. The relay unit is arranged in the room in which the remote controller is disposed. The relay unit includes a receiving section for receiving the operation signal transmitted from the remote controller, and a transmitting section for transmitting the operation signal to the receiver unit 14.

In the bar lock according to the embodiment of the present invention, the door is locked or unlocked in accordance with the unlock signal transmitted from the remote controller. Therefore, it is difficult to unlock the door from the outside of the building. If the voltage of a battery in the power source 18 is lowered, and the function of the receiver unit 14 is lowered, then the door cannot be unlocked. However, the door is locked, and hence it is difficult to unlock the door from the outside of the building.

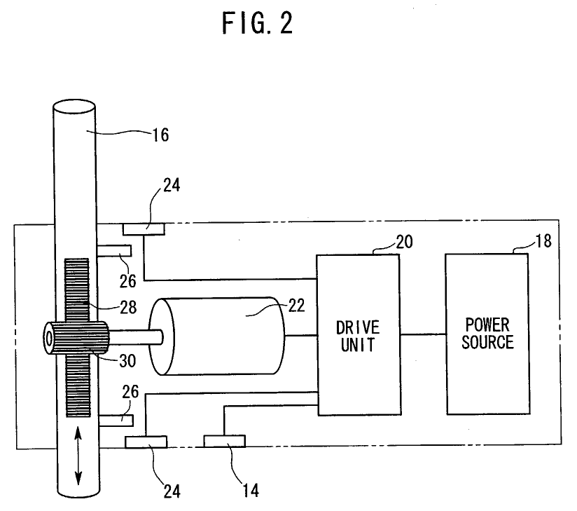

An example of the bar lock according to the embodiment of the present invention is shown in FIG. 2.

When a receiver unit 14 receives an lock signal transmitted from an unillustrated remote controller, a drive unit 20 is driven on the basis of the lock signal to rotate a motor 22. Accordingly, teeth 28, which are formed on a surface of the bar 16, are meshed with a gear 30 attached to the motor 22, and the bar 16 is moved in the downward direction as shown in FIG. 2. When the bar 16 is moved in the downward direction, a projection 26, which is attached to the bar 16, abuts against a detecting section 24. In this situation, an unillustrated detection signal is transmitted from the detecting section 24 to the drive unit 20. Accordingly, the drive unit 20 can recognize that the bar 16 has been moved to a predetermined position. The drive unit 20 stops the rotation of the motor 22 on the basis of the detection signal. Accordingly, the bar 16 is stopped at the predetermined position, and thus an unillustrated double sliding door is locked. When the receiver unit 14 receives an unlock signal transmitted from the remote controller, the motor 22 is rotated in a opposite direction to the direction of rotation as described above. Accordingly, the bar 16 is moved in the upward direction as shown in FIG. 2, and thus the door is unlocked.

In the bar lock described above, the bar 16 is moved in accordance with the rotation of the motor 22. However, in the bar lock according to the embodiment of the present invention, the bar 16 can be also moved by using a solenoid. In this case, it is unnecessary to provide the projection 26 of the bar 16 and the detecting section 24.

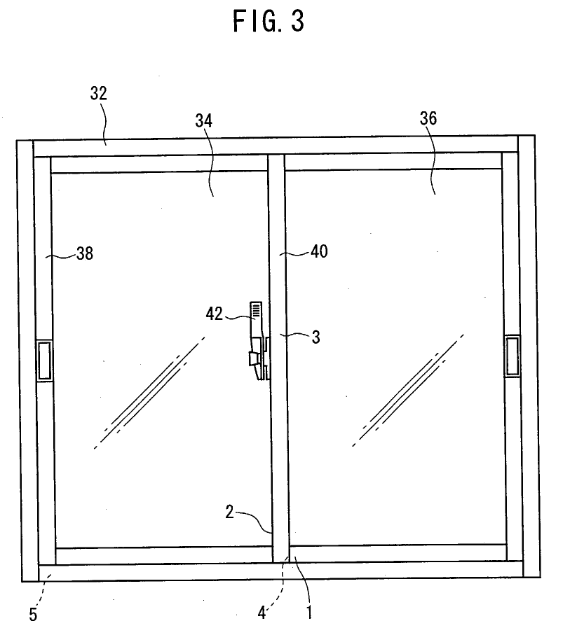

FIG. 3 shows a window to which the bar lock is installed. The window has an outer frame 32, an outer panel 34, and an inner panel 36. A crescent lock 42 is attached on the panel 36. The window is locked by fixing the panels 34, 36 by the crescent lock 42.

The bar lock according to the embodiment of the present invention is installed to attachment places 1 to 4 provided for a window frame 40 of the panel 36 or to an attachment place 5 provided for the frame 32.

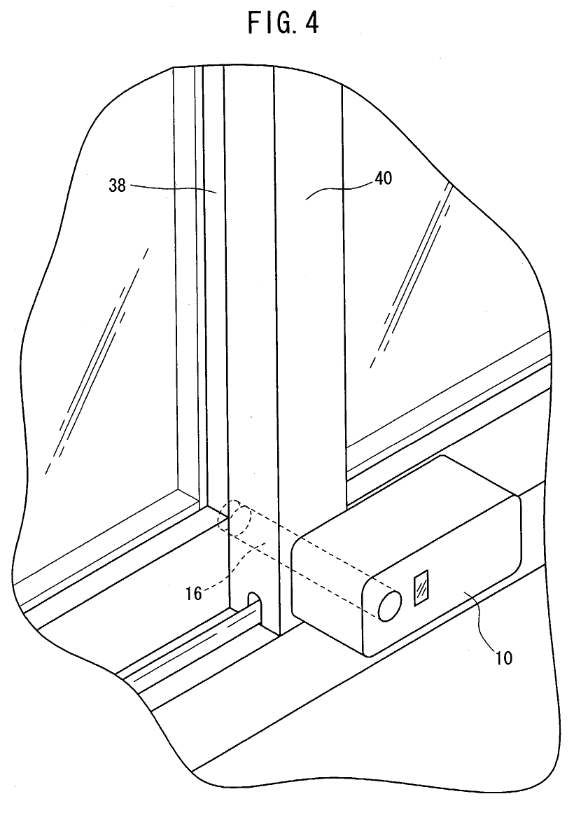

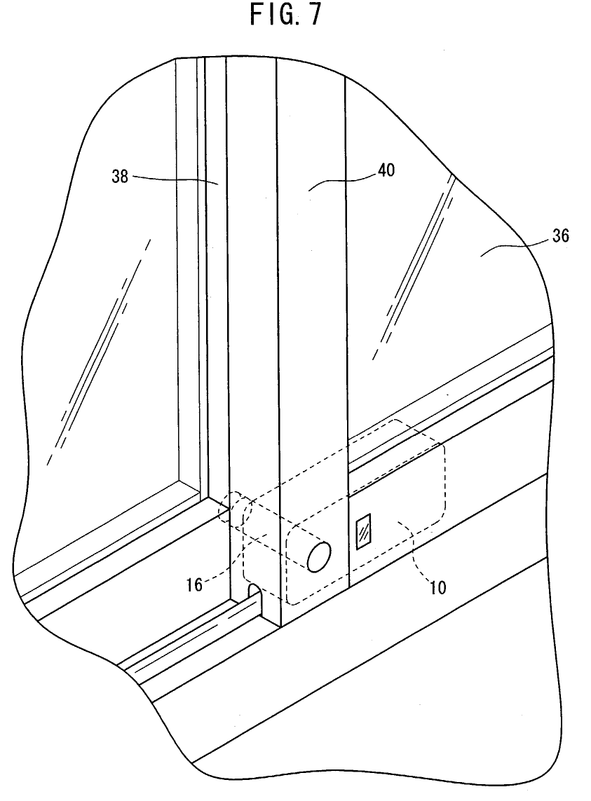

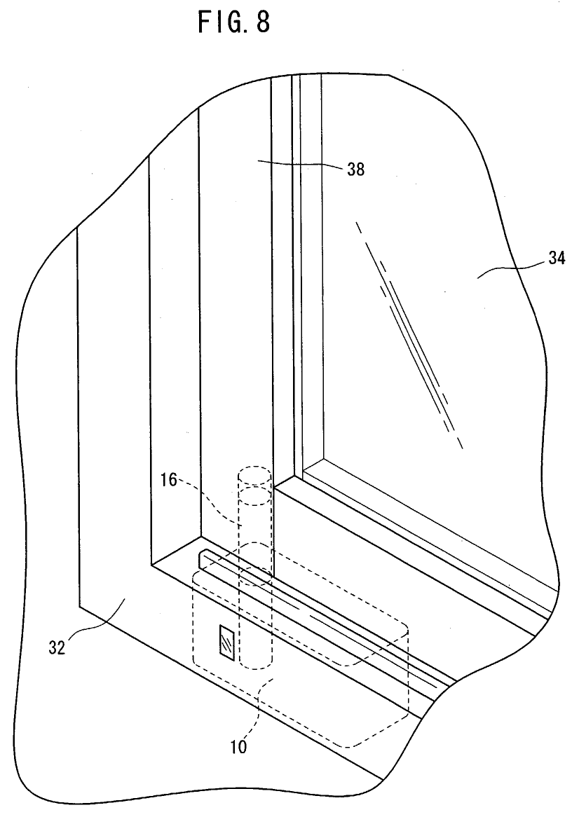

When the bar lock is attached to the places 1 to 3, the bar lock is attached on the frame 40 as shown in FIGS. 4 to 6. When the bar lock is attached to the place 4 shown in FIG. 3, the bar lock is embedded in the panel 36 as shown in FIG. 7. When the bar lock is attached to the place 5 shown in FIG. 3, the bar lock is embedded in the frame 32 as shown in FIG. 8.

FIG. 4 shows the bar lock attached on the place 1 of the frame 40 shown in FIG. 3. When the lock signal is transmitted from the unillustrated remote controller to the main body 10 shown in FIG. 4, then the bar 16 is moved on the basis of the lock signal, and the bar 16 penetrates through the frames 38, 40. Accordingly, the frames 38, 40 are fixed, and the window is locked.

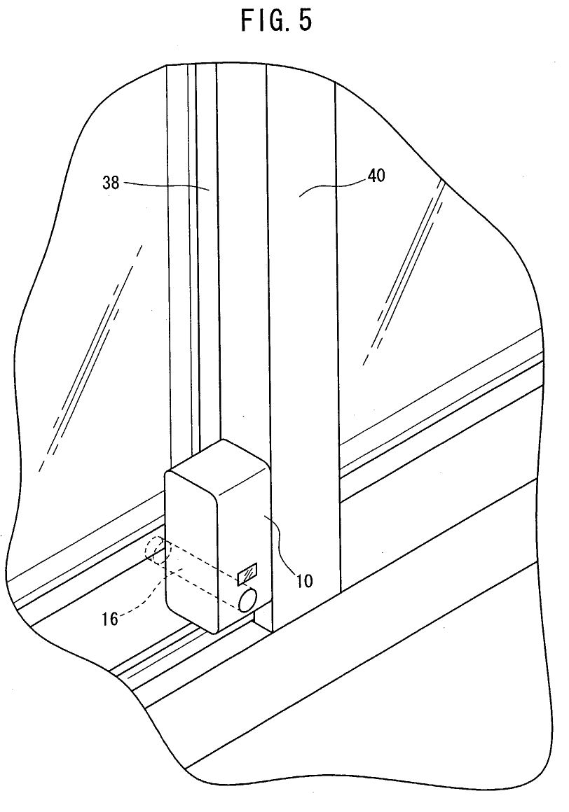

FIG. 5 shows the bar lock attached to the place 2 of the frame 40 shown in FIG. 3. When the lock signal is transmitted from the unillustrated remote controller to the main body 10 shown in FIG. 5, then the bar 16 is moved on the basis of the lock signal, and the bar 16 is inserted into the frame 38. The main body 10 is attached on the frame 40. Therefore, the frame 38, 40 are fixed by the main body 10 and the bar 16, and the window is locked.

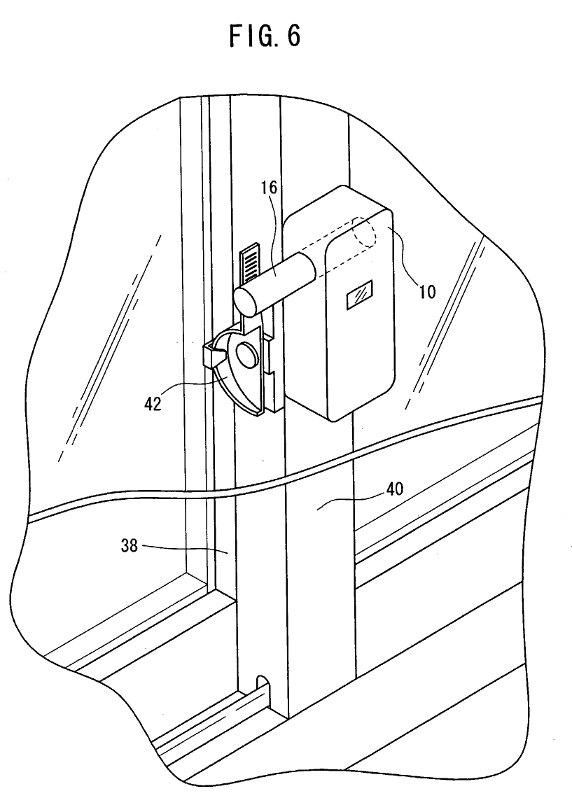

FIG. 6 shows the bar lock attached to the place 3 of the frame 40 shown in FIG. 3. When the lock signal is transmitted from the unillustrated remote controller to the main body 10 shown in FIG. 6, then the bar 16 is moved on the basis of the lock signal, and the bar 16 protrudes from the main body 10. In this situation, the bar 16 protrudes from the main body 10 so that it is difficult to unlock the crescent lock 42 attached on the frame 40. Accordingly, the crescent lock 42, and the frames 38, 40 are fixed, and the window is locked. In this case, in order to prevent the unlocking of the window by moving the bar 16 based on pressing the bar 16, an unillustrated fixing mechanism, which fixes the bar 16 when the window is locked, is disposed in the main body 10.

FIG. 7 shows the bar lock embedded in the frame 40. In this case, the same function and the same effect as those of the bar lock shown in FIG. 5 are obtained.

FIG. 8 shows the bar lock embedded in the frame 32 or in the wall. When the lock signal is transmitted from the unillustrated remote controller to the main body 10, then the bar 16 is moved on the basis of the lock signal, and the bar 16 penetrates through the frame 38. Accordingly, the panel 34 is fixed, and the window is locked.

In this case, it is impossible to fix the panels 34, 36 by one bar lock. Therefore, it is necessary to attach another bar lock for the panel 36. When the bar lock is embedded in the frame 32, the bar lock is not moved with the panel 34. Therefore, an unillustrated domestic power source can be used as the power source 18 shown in FIGS. 1 and 2 in place of the battery. Accordingly, it is possible to omit the operation to exchange the battery. Further, when the domestic power source is used, the operation signal, which is transmitted from the remote controller to the main body 10, can be transmitted via the electric wire connected between the domestic power source and the main body 10.

In the case of the bar lock shown in FIG. 8, the bar 16 protrudes from the main body 10 when the window is unlocked. In the case, the window can be locked by pushing the bar 16 with a finger. When a fixing mechanism for fixing the bar 16 is disposed in the main body 10, the end of the bar 16 does not protrude from the main body 10 even if the window is unlocked.

What is claimed is:

1. A bar lock for a double sliding door, comprising a receiver unit for receiving an operation signal transmitted from a remote controller, a bar for locking the door, a drive unit for moving the bar on the basis of said operation signal, and a power source, wherein
said door is locked or unlocked in accordance with said movement of said bar; and
said door is locked when said bar is inserted into a frame of said door.

2. A bar lock for a double sliding door, comprising a receiver unit for receiving an operation signal transmitted from a remote controller, a bar for locking the door, a drive unit for moving the door on the basis of said operation signal, a power source, and a fixing unit for fixing said bar when said double sliding door is locked in accordance with said movement of said bar, wherein
said door is locked or unlocked in accordance with said movement of said bar; and
said door is locked when a crescent lock installed to said door is fixed by said bar.

3. The bar lock according to claim 1, wherein said door is unlocked when said receiver unit receives an unlock signal of said operation signal.

4. The bar lock according to claim 3, further comprising a main body including said receiver unit, said drive unit, said bar, and said power source.

5. The bar lock according to claim 4, wherein said bar is confined in said main body and said frame when said door is locked.
